(19) United States
(12) Patent Application Publication
(10) Pub. No.: US 2026/0041061 A1
(43) Pub. Date: Feb. 12, 2026

(54) PET TOY BALL ASSEMBLY SYSTEM AND METHOD

(71) Applicant: BYZ Productions Inc., Canoga Park, CA (US)

(72) Inventors: Bar Zur, Canoga Park, CA (US); Eran Mordechay, Tel Aviv (IL); Dor Leibman, Tel Aviv (IL)

(21) Appl. No.: 19/272,068

(22) Filed: Jul. 17, 2025

Related U.S. Application Data
(60) Provisional application No. 63/682,210, filed on Aug. 12, 2024.

(51) Int. Cl. A01K 15/02

(52) U.S. Cl. CPC A01K 15/0252; A01K 15/021

(57) ABSTRACT

A pet toy ball system that includes first and second ball assemblies that are configured to be or are wirelessly connected to one another. The first ball assembly is configured to perform a first movement action or first pet attention action during a first predetermined period of time, and the second ball assembly is configured to perform a second movement action or second pet attention action during a second predetermined period of time.

### CROSS-REFERENCE TO RELATED APPLICATIONS

This application claims the benefit of U.S. Provisional Application No. 63/682,210, filed on Aug. 12, 2024, the entirety of which is incorporated by reference herein.

### FIELD OF THE INVENTION

The present invention relates to a toy ball assembly for use with dogs and a system for wireless communication between multiple toy ball assemblies.

### BACKGROUND OF THE INVENTION

It is important for dogs to stay active. However, dog owners are often short on time to walk, play with or otherwise engage their dogs in physical activity. The present invention is directed to keeping dogs active without the need for human interaction.

The background description disclosed anywhere in this patent application includes information that may be useful in understanding the present invention. It is not an admission that any of the information provided herein is prior art or relevant to the presently claimed invention, or that any publication specifically or implicitly referenced is prior art.

### SUMMARY OF THE PREFERRED EMBODIMENTS

In accordance with a first aspect of the present invention there is provided a pet toy ball assembly that includes an outer shell that includes a first outer shell portion and a second outer shell portion that cooperate to define a shell interior, a first receiver member secured to an inner surface of the first outer shell portion, a second receiver member secured to an inner surface of the second outer shell portion, and an inner control assembly positioned in the shell interior. The inner control assembly includes a housing with a motor, a controller and a wireless communication module disposed therein. A first protrusion extends through a protrusion opening defined in the housing and into the first receiver member. The first protrusion is operably connected to the motor and is rotatable within the protrusion opening. The housing includes a second protrusion member that is received in the second receiver member. Interaction of the first protrusion member with the outer shell and/or the first receiver member causes the pet toy ball assembly to perform a movement action. The first receiver member may include a non-circular recess and the second receiver member may include a circular recess. Rotation of the first protrusion member may cause the pet toy ball assembly to spin.

The inner control assembly may include a button member and a charging jack, and neither the button member nor the charging jack are accessible from an exterior of the outer shell when the first and second outer shell portions are secured to one another. In other words, when the first and second outer shell portions are in the closed position (e.g., threaded together with the inner control assembly inside), the charging jack and button member cannot be accessed. The controller may be configured to control an aspect of the toy ball assembly to cause a pet attention action to occur. The pet attention action may be a sound, a light, a movement (e.g., spinning, shaking, vibrating, rolling), which may be referred to herein as movement action, sound action or a visual action. All of these actions are designed to get the attention of a pet. The inner control assembly may include a speaker, and the speaker may be configured to emit the sound action.

Preferably, the inner control assembly includes at least one LED, the outer shell includes transparent portions defined therein, and light emitted by the at least one LED is visible through the transparent portions of the outer shell. The inner control assembly includes a control button associated with the controller. The button member, which is disposed on and movable with respect to the housing is associated with or aligned with the control button, such that movement of the button member (e.g., pressing inwardly) activates the control button.

In accordance with another aspect of the present invention there is provided a pet toy ball system that includes first and second ball assemblies that are configured to be wirelessly connected to one another. The first ball assembly is configured to perform a first movement action during a first predetermined period of time, and the second ball assembly is configured to perform a second movement action during a second predetermined period of time. The first movement action may be spinning and the second movement action may be spinning. The first ball assembly may be configured to perform a pet attention action that is different than the movement action, where the pet attention action is at least one of a sound action or a visual action.

The present invention includes any methods related to the toy ball assembly and or system related thereto. For example, a method of activating the toy ball assembly may include opening the outer shell by disconnecting the first and second outer shell portions, accessing the inner control assembly, pressing the button member to initiate a single play mode. Where the single play mode includes a movement action, such as spinning in first and second or opposite directions or any other described herein. The different movement or pet attention actions may occur within or after predetermined periods of time. The method may also include closing placing the inner control assembly back in the outer shell and allowing the toy ball assembly to perform a routine that includes at least one pet attention action. The method may also include wirelessly connecting the toy ball assembly to a second toy ball assembly, positioning the first toy ball assembly in a first location (such as a first room), positioning the second toy ball assembly in a second location (such as a second room), starting a routine, system or the like, where the first toy ball assembly performs a first pet attention action (such as spinning) and after a predetermined period of time the second toy ball assembly performs another pet attention action, such as making a nose (a sound action) that alerts the pet to go to the second location. Any set of steps and pet attention actions that can be gleaned from this disclosure is within the scope of the present invention and within the scope of the claims.

The self-spinning ball entertains dogs on its own, without need for human interaction. The ball may spin and roll unpredictably, encouraging dogs to chase and play independently. Preferably, the ball assembly includes a hard shell to protect the inner electronics and components, and also includes a soft rubber layer on the outside thereof to protect the dog. The one or more control buttons may be included on an inner control assembly that is removable from the outer shell for control of the ball assembly and for recharging. The ball assembly may sync with other units or ball assemblies via Bluetooth or other wireless connectivity for collaborative play. When connected, the balls are programmed to coordinate movements to create unique and engaging patterns that challenge and entertain dogs.

It will be appreciated that the ball assembly and the system include a number of operative features, modes, uses and the like. Set forth below are a number of exemplary and non-limiting features, modes uses and the like. All colors, dimensions, time periods, etc. are only exemplary and non-limiting. Exemplary button functions are provided. It will be appreciated that the use of the present invention with pets is not limiting and the present invention may be used with kids or other humans as well. Use of the term pet herein or in the claims does not limit the scope of protection.

When the ball assembly or system is in “single mode” (single ball assembly or play mode), or to place the system in single mode, the button is pressed for three seconds. Until the button is pressed for three seconds, nothing works (no LED, no BLE, no sound). When the button is pressed for three seconds, the LED blinks green once and then (when button is released) the LED stays green and the BLE (Bluetooth low energy) is turned on. This state is considered “single standby mode” and is waiting for the user to choose a program or start the chosen program. A double click at this stage, changes from Program A to B and back. The LED color changes from green (program A) to yellow (program B) to indicate which program is chosen, but the program does not start yet. A three second press at this stage starts the chosen program. A whistle sound is played, and the LED starts to blink in the color of the chosen color for ten seconds (this indicates to the user the program is about to begin, and they need to put the inner control assembly inside the ball or shell). After the ten second delay, the motor starts according to the chosen program and the LED is in colorful mode.

When the ball assembly or system is in “multi-mode” (multi-ball assembly or play mode) or to place the system in multi-mode, the button is pressed for five seconds, the LED blinks a blue color, until the ball assembly connects wirelessly with another ball assembly and then the LED stays on blue and a wolf howl sound is played. This state is considered “multi standby mode” and is waiting for the user to choose a program or start the chosen program. A double click at this stage, changes from Program A to B and back. The LED color changes from purple (program A) to orange (program B) to indicate which program is chosen, but the program does not start yet. A three second press at this stage starts the chosen program. The whistle sound is played, and the LED starts to blink in the color of the chosen color for ten seconds (this indicates to the user the program is about to begin, and he needs to put the device inside the ball). After the ten second delay, the motor starts according to the chosen program. To turn off the ball assembly, the button is pressed for ten seconds, the LED blinks red once and then (when button is released) the device is turned off.

The ball assembly and system may include a number programs, such as Single A, Single B, Multi A and Multi B. Single A includes the LED color as green, the motor provides spinning for forty seconds (switching direction every twenty seconds). During the program the LEDs may cycle through all colors. After forty seconds, the ball enters standby mode, but if the ball is moved, the motor is activated for another forty second session. The ball assembly may include a motion sensor, gyroscope, accelerometer or other motion sensing or other feature. If the ball is not moved for five minutes, it turns off.

Single B includes a yellow LED color. The motor spins forty seconds (switching direction every ten seconds. During the program the LEDs may cycle through all colors. After forty seconds, the ball enters standby mode. If the ball is moved it restarts the forty second session. If the ball is not moved for five minutes, it turns off.

Multi A includes the LED(s) as purple. In this mode, the first ball assembly spins (via the motor) for about twenty seconds and then the second ball assembly spins for about twenty seconds. The LEDs on the ball assembly that is active at a particular time light up purple. After the second ball assembly finishes, both balls enter standby mode. If either of the ball assemblies are moved, the program starts again. If the balls are not moved for five minutes, it turns off. Multi B includes the LED(s) as orange. Both ball assemblies (first and second ball assemblies) spin simultaneously in five second pulses or increments and then the first ball spins for thirty seconds and then both balls spin simultaneously for five seconds and then the second ball spins for thirty seconds. The ball that is active each time has orange LEDs on. After the second ball finishes, both balls enter standby mode. If either of the balls are moved the program starts again. If the balls are not moved for five minutes, it turns off.

### BRIEF DESCRIPTION OF THE DRAWINGS

FIG. 1 is a perspective view of a ball assembly in accordance with a preferred embodiment of the present invention;

FIG. 2 is perspective view of the ball assembly of FIG. 1 in an open position and showing the first and second outer shell portions and an inner control assembly;

FIG. 3 is an exploded view of the inner control assembly;

FIG. 4 is another exploded view of the inner control assembly;

FIG. 5 is a cross-section of the ball assembly taken along line 5-5 of FIG. 1;

FIG. 6 is a perspective view of first and second ball assemblies connected via wireless connectivity; and

FIG. 7 is a flow chart showing exemplary programming and operation of a pet toy ball system.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments. If a component is not shown in a drawing then this provides support for a negative limitation in the claims stating that that component is “not” present. However, the above statement is not limiting and in another embodiment, the missing component can be included in a claimed embodiment.

Reference in this specification to “one embodiment,” “an embodiment,” “a preferred embodiment” or any other phrase mentioning the word “embodiment” means that a particular feature, structure, or characteristic described in connection with the embodiment is included in at least one embodiment of the-disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional. Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used.

Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

In a preferred embodiment of the present invention, functionality is implemented as software executing on a server that is in connection, via a network, with other portions of the system, including databases and external services. The server comprises a computer device capable of receiving input commands, processing data, and outputting the results for the user. Preferably, the server consists of RAM (memory), hard disk, network, central processing unit (CPU). It will be understood and appreciated by those of skill in the art that the server could be replaced with, or augmented by, any number of other computer device types or processing units, including but not limited to a desktop computer, laptop computer, mobile or tablet device, or the like. Similarly, the hard disk could be replaced with any number of computer storage devices, including flash drives, removable media storage devices (CDs, DVDs, etc.), or the like.

The network can consist of any network type, including but not limited to a local area network (LAN), wide area network (WAN), and/or the internet. The server can consist of any computing device or combination thereof, including but not limited to the computing devices described herein, such as a desktop computer, laptop computer, mobile or tablet device, as well as storage devices that may be connected to the network, such as hard drives, flash drives, removable media storage devices, or the like.

The storage devices (e.g., hard disk, another server, a NAS, or other devices known to persons of ordinary skill in the art), are intended to be nonvolatile, computer readable storage media to provide storage of computer-executable instructions, data structures, program modules, and other data for the mobile app, which are executed by CPU/processor (or the corresponding processor of such other components). The various components of the present invention, are stored or recorded on a hard disk or other like storage devices described above, which may be accessed and utilized by a web browser, mobile app, the server (over the network), or any of the peripheral devices described herein. One or more of the modules or steps of the present invention also may be stored or recorded on the server, and transmitted over the network, to be accessed and utilized by a web browser, a mobile app, or any other computing device that may be connected to one or more of the web browser, mobile app, the network, and/or the server.

References to a “database” or to “database table” are intended to encompass any system for storing data and any data structures therein, including relational database management systems and any tables therein, non-relational database management systems, document-oriented databases, NoSQL databases, or any other system for storing data.

Software and web or internet implementations of the present invention could be accomplished with standard programming techniques with logic to accomplish the various steps of the present invention described herein. It should also be noted that the terms “component,” “module,” or “step,” as may be used herein, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C #, Java, Cobol, assembler, PERL, Python, PHP, or the like, or macros using Excel or other similar or related applications with various algorithms being implemented with any combination of data structures, objects, processes, routines or other programming elements.

The present invention is directed to a toy or ball assembly and a system and method for using or operating same. In an exemplary embodiment, the toy assembly may be used as a dog or other animal toy. However, this is not a limitation. In use, the toy assembly may be used to keep a dog active, for example by signaling the dog to move from one room to another based on the actions or signals of the toy assembly, or by the toy or ball assembly itself moving. Generally, the toy assembly may be part of a system that includes multiple or at least first and second toy assemblies that may be wirelessly communicated with one another (e.g., via BLE—Bluetooth Low Energy or other wireless protocol) and/or that may be communicated with a mobile device, such as a cell phone that includes a software application or “app” thereon that communicates with and/or controls one or more toy assemblies.

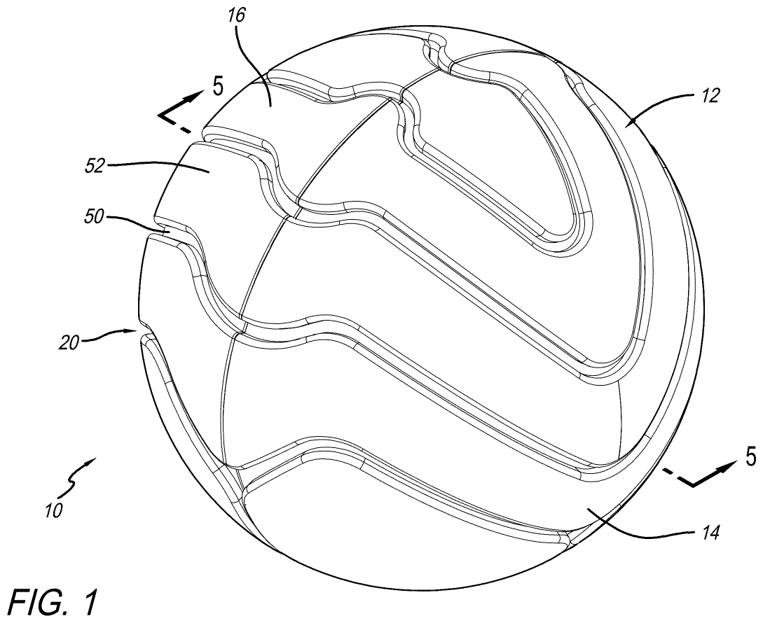

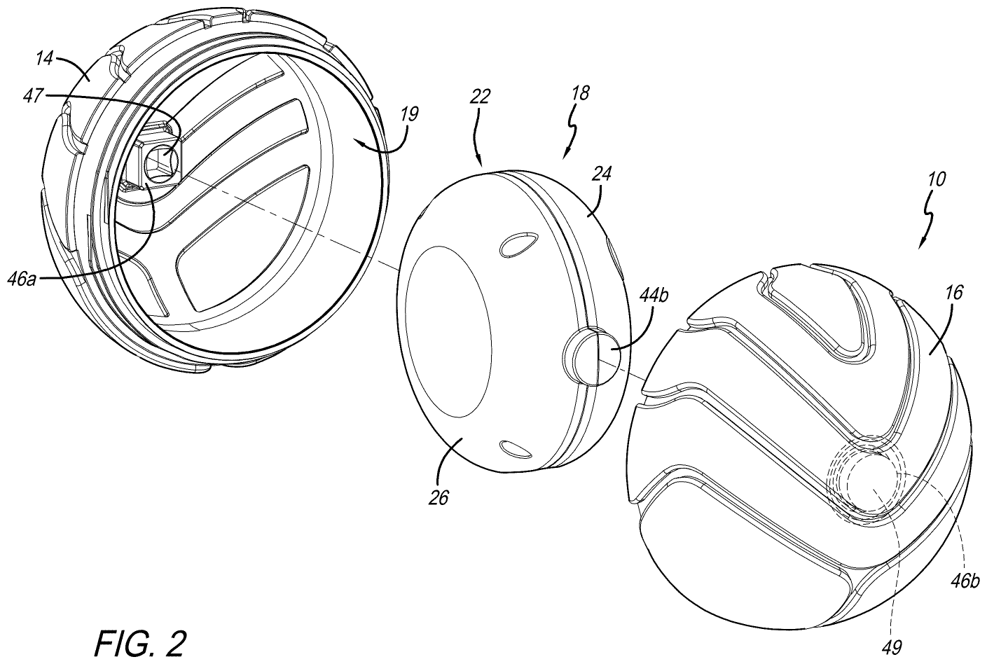

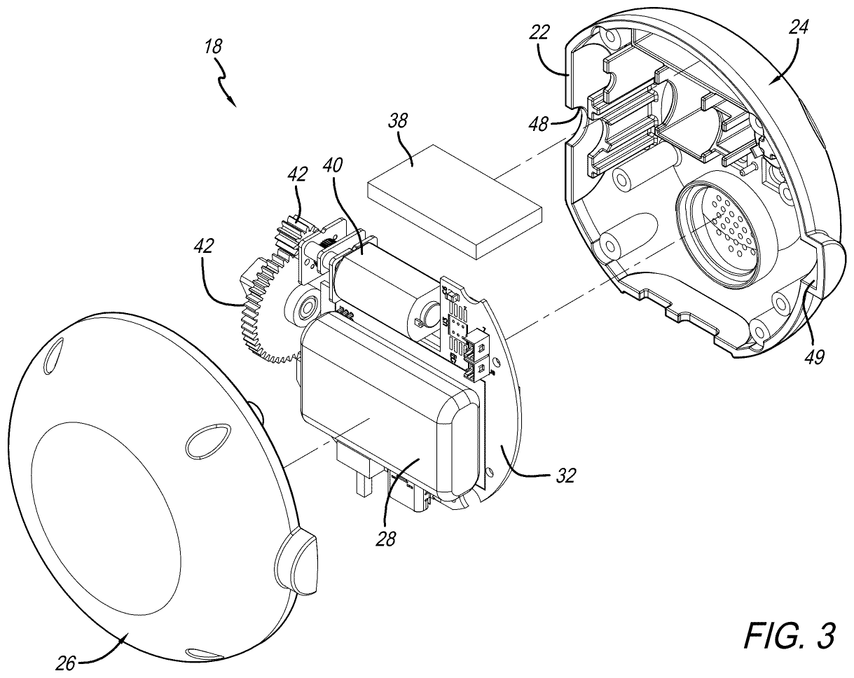

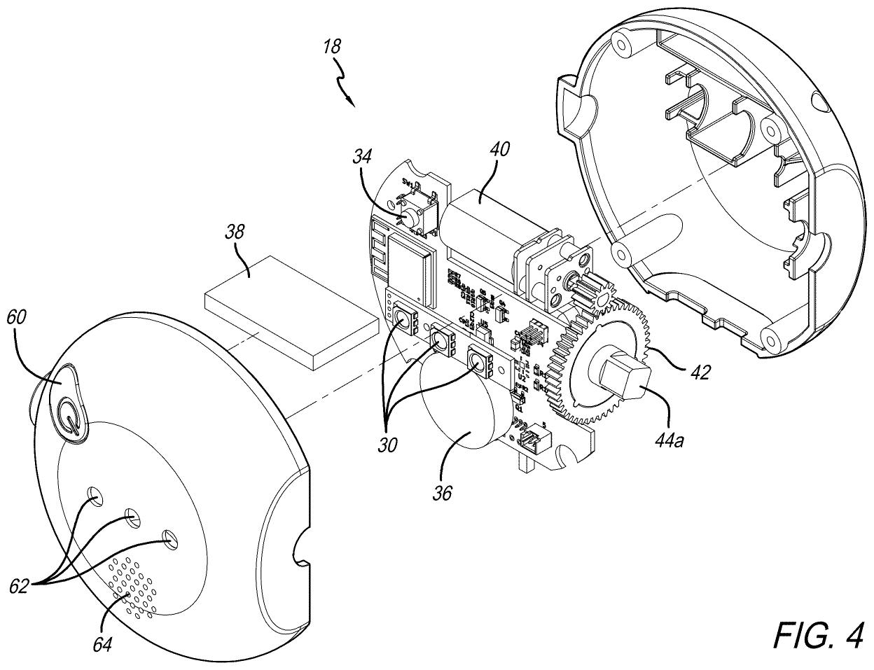

FIGS. 1-6 show an exemplary embodiment of a ball assembly 10 that includes an outer shell 12 with a first outer shell portion 14 and a second outer shell portion 16 and an inner control assembly 18. The first and second outer shell portions cooperate to define a shell interior 19. The outer shell 12 may have any outside shape, surface, texture or the like. For example, the outer shell 12 may be solid or may include grooves 20 or other indentations, raised portions or design elements, as shown in FIGS. 1 and 2. With reference to FIGS. 2-5, the inner control assembly 18 may include a housing 22 (with first and second housing portions 24 and 26), a battery 28, one or more lights or LEDs 30, a PCB 32 and/or controller (the controller may be part of the PCB or separate), a control button 34, a speaker 36, a weight 38, a motor 40, one or more gears 42 (which may be referred to herein as a gear train 42) connected to and operable by the motor, and a wireless communication module (which may be part of the PCB 32, the controller or the like).

In a preferred embodiment, some of the components of the ball assembly 10 may combine or interact to allow or cause the ball assembly to shake, spin, roll, jump or otherwise move, etc. One of the gears 42 may include a first protrusion member 44a extending outwardly therefrom that is received in a first receiver member 46a that is associated with or secured to or integral with the inside of the shell 12 (e.g., first shell outer shell portion 14), as shown in FIG. 2. Preferably, the first receiver member 46a includes a non-circular recess 47 (e.g., square shaped) and the first protrusion member 44a includes a corresponding shape. The interaction of the first protrusion member 44a, which extends through and is movable within a protrusion opening 48 in the housing 22, with the housing 22, may cause the ball assembly 10 to roll, shake or otherwise move. A second protrusion member 44b may be received in a second receiver 46b in the shell 12 (e.g., second outer shell portion 16). Preferably, the second receiver member 46b includes a circular or round recess 49 and the second protrusion member 46a includes a corresponding shape. As shown, first protrusion member 44a may include corners thereon, which fits into the opening in the correspondingly shaped first receiver 46a (matingly engaged). The gear 42 may rotate the first protrusion member 44a. The second protrusion member 44b and second receiver 46b may be matingly engaged and circular, this allows the second protrusion member 44b to rotate within the second receiver 46b. The shapes of these components may allow the motor, via the gears, to move, spin or roll the ball assembly (e.g., the outer shell 12 may rotate, while the inner control assembly 18 does not rotate, thus rolling, spinning or moving the ball). Any of rolling, spinning, moving or the like may be referred to herein as a movement action. It will be appreciated that any movement action is within the scope of the present invention and may be used to cause a pet to notice and/or interact with the ball assembly. In another embodiment, one or more of the receivers may rotate with the corresponding protrusion member. In other words, the receiver and corresponding protrusion member may rotate with respect to the housing to spin or rotate the outer shell 12 and/or ball.

In a preferred embodiment, the outer shell may include transparent portions 50 or strips and non-transparent portions 52. The transparent portions 50 allow light from the LEDs to be transmitted therethrough. This allows the transparent portions 50 to light up or show different colors, which may indicate different modes or features, such as green for on, yellow for standby, blue for pairing mode or Bluetooth connection made and red for off. The control button 34 may be utilized to cycle through different modes or for turning the inner control assembly 18 on or off. For example, a three second press of the button may turn the control assembly on, a five second press may turn the control assembly off, a double press may switch programs or modes (e.g., single unit use to multi-unit use) and a three second press, while the unit is already on may initiate a Bluetooth connection (with another ball assembly and/or with a mobile device that includes an app for controlling the system). More than one button may be included. One or more buttons or button members 60 that correspond to the control button 34 on the inner control assembly 18 may also be included on the outer shell 12 as well. Light openings 62 may be defined in one or more of the first and second housing portions 24 and 26 that correspond to the various LEDs 30.

Speaker openings 64 may be defined in one or more of the first and second housing portions 24 and 26 that correspond to the speaker 36.

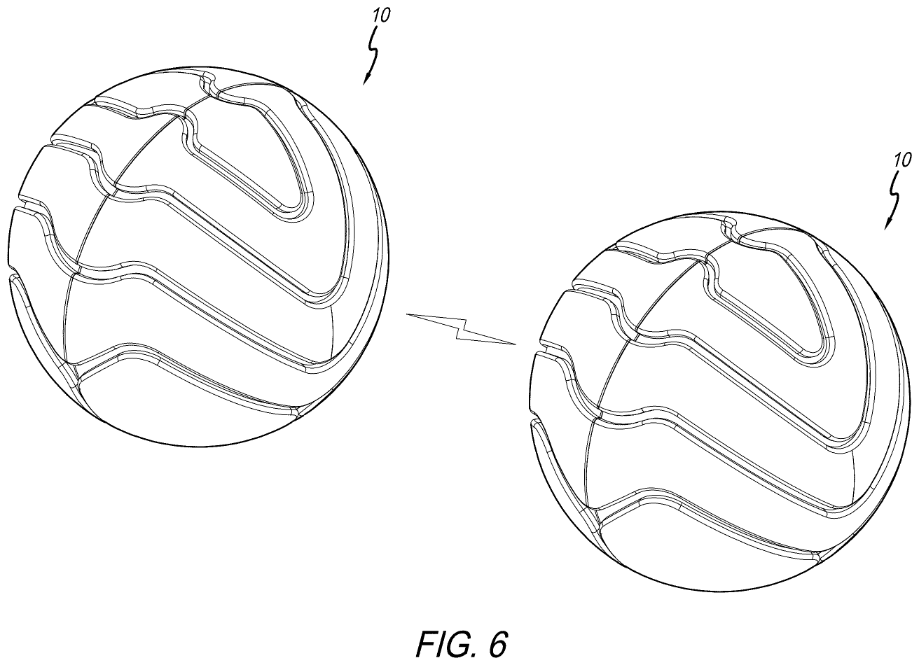

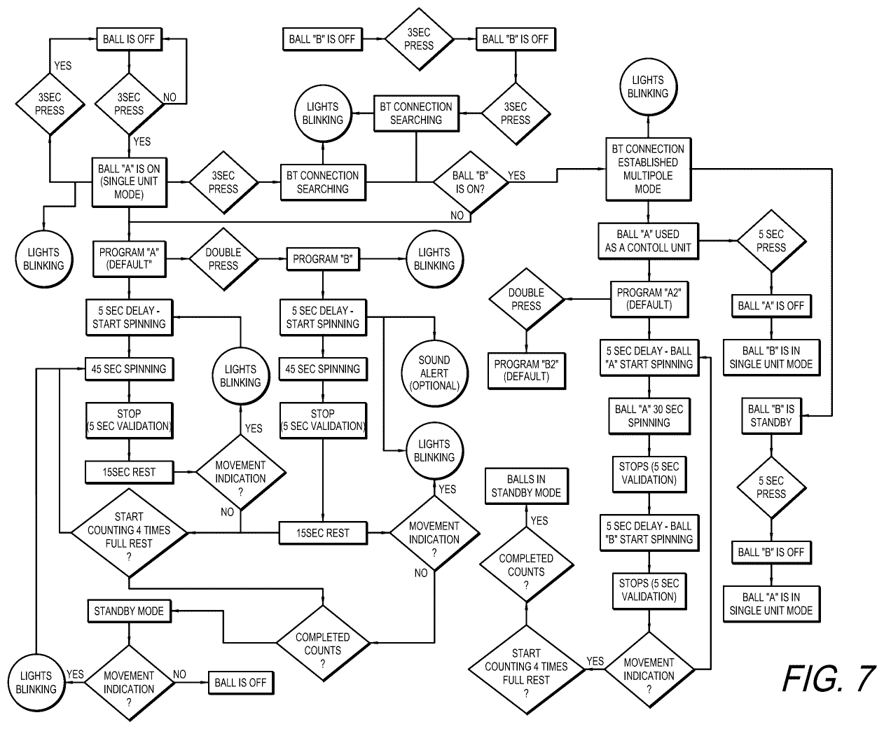

FIG. 7 shows an example of the logic that may be programmed into the device, e.g., into the controller and/or PCB 32 or other the like. As discussed above, a first ball assembly may be communicated with a second ball assembly so that they interact with one another and this may be referred to herein or may be considered a pet toy ball system. See, e.g., “multiple units use” in FIG. 7, which is also represented by the two ball assemblies 10 shown in FIG. 6. A person of ordinary skill in the art, from a review of the logic and flow chart(s) of FIG. 7 and the other discussion herein will understand the exemplary use thereof. The default mode may be single unit mode (program A) which includes, for example, 45 seconds of spinning at high RPM followed by 15 seconds rest. It may also include a change of motor rotation direction every 15 seconds. Program B may be 45 seconds of spinning at middle RPM followed by 15 seconds rest all in a single rotation direction. Program C may be multiple units mode. Therefore, speed of rotation, speed of shaking, direction of rotation, and duration of all these factors, etc. may all be variable. All dimensions, lengths, measurements, times, etc. or all exemplary and not limiting.

FIG. 7 illustrate(s) one or more flow charts and methodologies in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events.

The speaker 36 may also emit sounds, voices, commands, alerts, etc. for use in the various programs. These may be for instructing the human user and/or for interacting with, alerting or calling the animal or dog. For example, in single-unit mode, an alert or sound may be emitted to “call” the dog to the ball assembly. The ball assembly may then start spinning or moving to interest the dog further. In multi-unit mode, after the dog has been alerted to start playing with the first ball assembly, an alert or sound may be emitted from the second ball assembly (or third, etc.) to “call” the dog to another room to get the dog to run to the second ball assembly. This can be done multiple times to get the dog to run back and forth, thereby providing exercise for the dog. Any time of sound, command, voice, etc. is within the scope of the present invention. The ball assembly or system may also include a sensor or the like for sensing movement and/or to sense if the dog is nearby or touching the device.

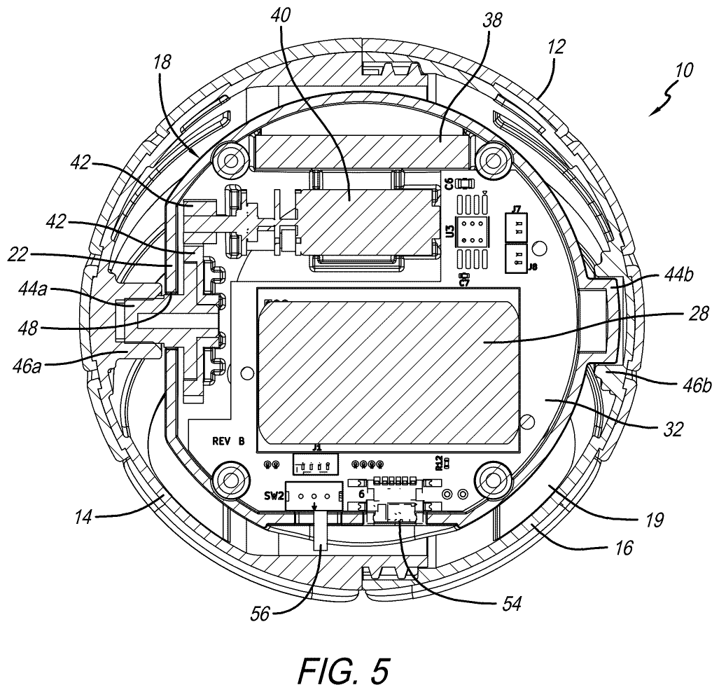

The outer shell may include a rubber/silicone or other soft material on the outside thereof (e.g., the non-transparent portions) and a hard transparent inner material. Thus allowing the grooves and/or transparent portions to be formed via strategic placement of the rubber or non-transparent portions. As shown in FIG. 2, the closing mechanism of the outer shell may threads. Latches, clasps, buttons and other closing mechanisms are within the scope of the present invention. This allows a user to remove the inner control assembly 18 so that it may be charged or replaced, etc. The control assembly may include a charging jack 54, as shown in FIG. 5, or may include a switch 56.

The system may also include machine learning so that the system may learn a specific user or specific dog or other animal that will be using the device. Therefore, customizing the system so that, for example, the device wakes up and begins operating more often for a more active dog or taking longer to wake up for a less active or older dog. The data gathered and analyzed may improve the functionality of the ball assembly and system.

As described herein, the above components and setup/operation software and firmware may vary depending on the desired vendors and equipment to be used in connection with the indoor tracking system and method. Accordingly, the aforementioned setup and verification process is exemplary and other methodologies may be utilized within the scope of the present invention.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

Although the operations of any method(s) disclosed or described herein either explicitly or implicitly are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

The teachings of the disclosure provided herein can be applied to other systems, not necessarily the system described above. The elements and acts of the various embodiments described above can be combined to provide further embodiments. Any measurements or dimensions described or used herein are merely exemplary and not a limitation on the present invention. Other measurements or dimensions are within the scope of the invention.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S. C. § 112, ¶6, other aspects may likewise be embodied as a means-plus-function claim, or in other forms, such as being embodied in a computer-readable medium. (Any claims intended to be treated under 35 U.S.C. § 112, ¶6 will include the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A pet toy ball assembly comprising:
an outer shell that includes a first outer shell portion and a second outer shell portion that cooperate to define a shell interior, a first receiver member secured to an inner surface of the first outer shell portion, a second receiver member secured to an inner surface of the second outer shell portion, and
an inner control assembly positioned in the shell interior, wherein the inner control assembly includes a housing with a motor, a controller and a wireless communication module disposed therein, wherein a first protrusion extends through a protrusion opening defined in the housing and into the first receiver member, wherein the first protrusion is operably connected to the motor and is rotatable within the protrusion opening, wherein the housing includes a second protrusion member that is received in the second receiver member, wherein interaction of the first protrusion member with the first receiver member causes the pet toy ball assembly to perform a movement action.

2. The pet toy ball assembly of claim 1 wherein the first receiver member includes a non-circular recess and the second receiver member includes a circular recess.

3. The pet toy assembly of claim 2 wherein rotation of the first protrusion member causes the pet toy ball assembly to spin.

4. The pet toy ball assembly of claim 1 wherein the inner control assembly includes a button member and a charging jack, and wherein neither the button member nor the charging jack are accessible from an exterior of the outer shell when the first and second outer shell portions are secured to one another.

5. The pet toy ball assembly of claim 1 wherein the controller is configured to cause a pet attention action to occur, wherein the pet attention action is one of the movement action, a sound action or a visual action.

6. The pet toy assembly of claim 5 wherein the inner control assembly includes a speaker, and wherein the speaker is configured to emit the sound action.

7. The pet toy ball assembly of claim 1 wherein the inner control assembly includes at least one LED, wherein the outer shell includes transparent portions defined therein, wherein light emitted by the at least one LED is visible through the transparent portions of the outer shell.

8. The pet toy ball assembly of claim 1 wherein the inner control assembly includes a control button associated with the controller, wherein the button member is disposed on the housing, wherein movement of the button member activates the control button.

9. The pet toy ball assembly of claim 1 wherein the wireless communication module is in wireless communication with a second pet toy ball assembly.

10. A pet toy ball assembly comprising:
an outer shell that includes a first outer shell portion and a second outer shell portion that cooperate to define a shell interior, a first receiver member secured to an inner surface of the first outer shell portion, a second receiver member secured to an inner surface of the second outer shell portion, wherein the outer shell includes transparent portions defined therein, and
an inner control assembly positioned in the shell interior, wherein the inner control assembly includes a housing with a motor, a controller and a wireless communication module disposed therein, wherein the motor is operably connected to a rotatable first protrusion that extends through a protrusion opening defined in the housing, wherein the first protrusion is received in a non-circular recess defined in the first receiver member, wherein the housing includes a second protrusion member that is received in a circular recess defined in the second receiver member, wherein rotation of the first protrusion member causes the pet toy ball assembly to spin, wherein the inner control assembly includes a button member and a charging jack, wherein neither the button member nor the charging jack are accessible from an exterior of the outer shell when the first and second outer shell portions are secured to one another, wherein the inner control assembly includes a speaker, wherein the inner control assembly includes at least one LED, wherein light emitted by the at least one LED is visible through the transparent portions of the outer shell, wherein the inner control assembly includes a control button associated with the controller, and wherein the button member is disposed on the housing, wherein movement of the button member activates the control button.

11. The pet toy ball assembly of claim 10 wherein the wireless communication module is in wireless communication with a second pet toy ball assembly.

12. A pet toy ball system comprising:
first and second ball assemblies that are configured to be wirelessly connected to one another, wherein the first ball assembly is configured to perform a first movement action during a first predetermined period of time, and wherein the second ball assembly is configured to perform a second movement action during a second predetermined period of time.

13. The pet toy system of claim 12 wherein the first movement action is spinning and the second movement action is spinning.

14. The pet toy system of claim 12 wherein the first ball assembly includes an outer shell with first and second outer shell portions that cooperate to define a shell interior, and an inner control assembly positioned in the shell interior, wherein the inner control assembly includes a button member and a charging jack.

15. The pet toy system of claim 14 wherein neither the button member nor the charging jack are accessible from an exterior of the outer shell when the first and second outer shell portions are secured to one another.

16. The pet toy system of claim 12 wherein the first ball assembly is configured to perform a pet attention action that is different than the movement action, wherein the pet attention action is at least one of a sound action or a visual action.
